(19) United States
(12) Patent Application Publication
(10) Pub. No.: US 2009/0221350 A1
(43) Pub. Date: Sep. 3, 2009

(54) Gaming Machine Using Special Symbol To Be Variably Displayed And Playing Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/211,226

(22) Filed: Sep. 16, 2008

Related U.S. Application Data
(60) Provisional application No. 61/033,091, filed on Mar. 3, 2008.

(51) Int. Cl. A63F 9/24; A63F 13/00

(52) U.S. Cl. 463/20

(57) ABSTRACT

A slot machine 1 of the invention includes a display area 150 in which a plurality of symbols 180 are arranged; a game that awards a payout in accordance with a relation among the symbols 180 arranged; and a controller 100. The controller rearranges the symbols 180 on the display area 150, based on a predetermined timing; determines whether the symbols 180 rearranged on the display area 150 include a special symbol 190; when it is determined that a special symbol 190 is included, starts a variable display in the area in which the special symbol 190 is rearranged; rearranges any one of the symbols 180 except the special symbol 190, as a stop mode of the variable display in the area in which the special symbol 190 is rearranged; and awards a payout in accordance with a relation among the symbols 180 rearranged.

### CROSS REFERENCE TO RELATED APPLICATION

The present application claims priority from provisional application No. 61/033,091, which was filed on Mar. 3, 2008, the entire disclosure of which is herein incorporated by reference.

### BACKGROUND OF THE INVENTION

1. Field of the Invention

The invention relates to a gaming machine and a playing method thereof.

2. Description of Related Art

The gaming machine includes a slot machine, for example. In a conventional slot machine, when a player inserts a game medium such as coin or bill into an insertion slot of the gaming machine and presses a start button, symbols are scroll-displayed in a display mounted on a front of a cabinet and the symbols are then stopped automatically.

In such gaming machine, as disclosed in U.S. Pat. No. 6,604,999 B2 or U.S. Patent No. 2002065124A1, for example, when the symbols stopped on a winning line constitute a predetermined combination, the predetermined numbers of game media are paid out as a win. In addition, when a certain symbol referred to as scatter symbol is displayed on the display, a predetermined number of game media are paid out in accordance with the number of scatter symbols displayed, irrespective of the winning line.

In the conventional slot machines, a bonus game may be executed when a predetermined condition is fulfilled, separately from a base game in which a predetermined number of game media are paid out in accordance with a combination of symbols or the number of scatter symbols. A player should understand a rule so as to determine a situation of whether a payout is awarded in the bonus game.

Accordingly, an object of the invention is to provide a slot machine having an entertainment characteristic, which is not provided to the above prior arts and is easy to a player, and a playing method thereof.

Another object of the invention is to provide a slot machine having an entertainment characteristic, which is easy to a player, and a playing method thereof.

### SUMMARY OF THE INVENTION

The invention provides a gaming machine having the following structures and including: a display area in which a plurality of symbols are arranged; a game that awards a payout in accordance with a relation among the symbols arranged; and a controller that is programmed to operate as described in the steps of (a1) to (a5). Specifically, the controller operates: (a1) to execute a first rearrangement of rearranging the symbols on the display area, based on a predetermined timing; (a2) to determine whether the symbols rearranged on the display area include a special symbol; (a3) when it is determined that the symbols include a special symbol, to start a variable display in the area in which the special symbol is rearranged; (a4) to execute a second rearrangement of rearranging any one of the symbols except the special symbol, as a stop mode of the variable display in the area; and (a5) to award a payout in accordance with a relation among the symbols rearranged, as a result of the first rearrangement and/or the second rearrangement.

According to the above structure, a first rearrangement of rearranging symbols in a display area based on a predetermined timing is executed. It is determined whether the symbols rearranged on the display area include a special symbol. When it is determined that the symbols include a special symbol, a variable display is started in the area in which the special symbol is rearranged. As a stop mode of the variable display in the area, any one of the symbols except the special symbol is rearranged. As a result of the first rearrangement and/or the second rearrangement, a payout is awarded in accordance with a relation among the symbols rearranged.

Thereby, a player who plays a game with the gaming machine can expect a payout by a result of the second rearrangement in the same display area as well as a payout by a result of the first rearrangement. Thus, an easy and new entertainment characteristic can be provided.

The invention provides a gaming machine having the following structures and including: a display area of a matrix type having a plurality of grids in which a plurality of symbols are respectively arranged; a game that awards a payout in accordance with a relation among the symbols arranged; and a controller that is programmed to operate as described in the steps of (b1) to (b5). Specifically, the controller operates: (b1) to execute a first rearrangement of rearranging the symbols on the display area, based on a predetermined timing; (b2) to determine whether the symbols rearranged on the display area include a special symbol; (b3) when it is determined that the symbols include a special symbol, to emphasizingly display an area of the grid in which the special symbol is rearranged and to start a variable display in the area of the grid; (b4) to execute a second rearrangement of rearranging any one of the symbols except the special symbol, as a stop mode of the variable display in the area; and (b5) to award a payout in accordance with a relation among the symbols rearranged, as a result of the first rearrangement and/or the second rearrangement.

According to the above structure, a first rearrangement is executed in which symbols are respectively rearranged in grids of a display area of a matrix type, based on a predetermined timing. It is determined whether the symbols rearranged on the display area include a special symbol. When it is determined that the symbols include a special symbol, an area of the grid in which the special symbol is rearranged is emphasizingly displayed and a variable display is started in the area. As a stop mode of the variable display in the area, any one of the symbols except the special symbol is rearranged. As a result of the first rearrangement and/or the second rearrangement, a payout is awarded in accordance with a relation among the symbols rearranged.

Thereby, a player who plays a game with the gaming machine can expect a payout by a result of the second rearrangement in the same display area as well as a payout by a result of the first rearrangement. Thus, an easy and new entertainment characteristic can be provided.

In addition, when a special symbol is rearranged, the grid of the area in which the special symbol is rearranged is emphasizingly displayed. Accordingly, a player can easily fix the eyes on the grid related to a result of the second rearrangement, so that an entertainment characteristic can be increased.

The invention provides a gaming machine having the following structures and including: a display area in which a plurality of symbols are arranged; a game that awards a payout in accordance with a relation among the symbols arranged; and a controller that is programmed to operate as described in the steps of (c1) to (c5). Specifically, the controller operates: (c1) to execute a first rearrangement of rearranging the symbols on the display area, based on a predetermined timing; (c2) to determine whether the symbols rearranged on the display area include a special symbol; (c3) when it is determined that the symbols include a special symbol, to determine whether there is a possibility that the payout is awarded; (c4) when there is a possibility that the payout is awarded, to start a variable display in the area in which the special symbol is rearranged; (c5) to execute a second rearrangement of rearranging any one of the symbols except the special symbol, as a stop mode of the variable display in the area; (c6) when there is no possibility that the payout is awarded, to prohibit the variable display in the area in which the special symbol is rearranged; and (c7) to award a payout in accordance with a relation among the symbols rearranged, as a result of the first rearrangement and/or the second rearrangement.

According to the above structure, a first rearrangement of rearranging symbols in a display area based on a predetermined timing is executed. It is determined whether the symbols rearranged on the display area include a special symbol. When it is determined that the symbols include a special symbol, a variable display is started in the area in which the special symbol is rearranged. As a stop mode of the variable display in the area, any one of the symbols except the special symbol is rearranged. As a result of the first rearrangement and/or the second rearrangement, a payout is awarded in accordance with a relation among the symbols rearranged.

Thereby, a player who plays a game with the gaming machine can expect a payout by a result of the second rearrangement in the same display area as well as a payout by a result of the first rearrangement. Thus, an easy and new entertainment characteristic can be provided.

In addition, when there is no possibility of a payout even though the second rearrangement has been performed, the second rearrangement is not executed. Accordingly, it is not necessary for a player to see the variable display that is not related to a payout, so that a player's stress can be relieved.

The invention provides a gaming machine having the following structures and including: a display area of a matrix type having a plurality of grids in which a plurality of symbols are respectively arranged; a game that awards a payout in accordance with a relation among the symbols arranged; and a controller that is programmed to operate as described in the steps of (d1) to (d7). Specifically, the controller operates: (d1) to execute a first rearrangement of rearranging the symbols on the display area, based on a predetermined timing; (d2) to determine whether the symbols rearranged on the display area include a special symbol; (d3) when it is determined that the symbols include a special symbol, to determine whether there is a possibility that the payout is awarded; (d4) when there is a possibility that the payout is awarded, to emphasizingly display an area of the grid in which the special symbol is rearranged and to start a variable display in the area of the grid; (d5) to execute a second rearrangement of rearranging any one of the symbols except the special symbol, as a stop mode of the variable display in the area; (d6) when there is no possibility that the payout is awarded, to prohibit the variable display in the area in which the special symbol is rearranged; and (d7) to award a payout in accordance with a relation among the symbols rearranged, as a result of the first rearrangement and/or the second rearrangement.

According to the above structure, a first rearrangement of rearranging symbols based on a predetermined timing is executed. It is determined whether the symbols rearranged on the display area include a special symbol. When it is determined that the symbols include a special symbol, a variable display is started in the area in which the special symbol is rearranged. As a stop mode of the variable display in the area, any one of the symbols except the special symbol is rearranged. As a result of the first rearrangement and/or the second rearrangement, a payout is awarded in accordance with a relation among the symbols rearranged.

Thereby, a player who plays a game with the gaming machine can expect a payout by a result of the second rearrangement in the same display area as well as a payout by a result of the first rearrangement. Thus, an easy and new entertainment characteristic can be provided.

In addition, when a special symbol is rearranged, the grid of the area in which the special symbol is rearranged is emphasizingly displayed. Accordingly, a player can easily fix the eyes on the grid related to a result of the second rearrangement, so that an entertainment characteristic can be increased.

In addition, when there is no possibility of a payout even though the second rearrangement has been performed, the second rearrangement is not executed. Accordingly, it is not necessary for a player to see the variable display that is not related to a payout, so that a player's stress can be relieved.

The invention provides a playing method of a gaming machine using a display area in which a plurality of symbols are arranged, a game that awards a payout in accordance with a relation among the symbols arranged and a controller that is programmed to operate as described in the following steps. The method includes the steps of: executing a first rearrangement of rearranging the symbols on the display area, based on a predetermined timing; determining whether the symbols rearranged on the display area include a special symbol; when it is determined that the symbols include a special symbol, starting a variable display in the area in which the special symbol is rearranged; executing a second rearrangement of rearranging any one of the symbols except the special symbol, as a stop mode of the variable display in the area; and awarding a payout in accordance with a relation among the symbols rearranged, as a result of the first rearrangement and/or the second rearrangement.

According to the above structure, a first rearrangement of rearranging symbols in a display area based on a predetermined timing is executed. It is determined whether the symbols rearranged on the display area include a special symbol. When it is determined that the symbols include a special symbol, a variable display is started in the area in which the special symbol is rearranged. As a stop mode of the variable display in the area, any one of the symbols except the special symbol is rearranged. As a result of the first rearrangement and/or the second rearrangement, a payout is awarded in accordance with a relation among the symbols rearranged.

Thereby, a player who plays a game with the gaming machine can expect a payout by a result of the second rearrangement in the same display area as well as a payout by a result of the first rearrangement. Thus, an easy and new entertainment characteristic can be provided.

### BRIEF DESCRIPTION OF THE DRAWINGS

Other and further objects, features and advantages of the invention will appear more fully from the following description taken in connection with the accompanying drawings, in which:

FIG. 1 illustrates a playing method of a gaming machine;

FIG. 2 is a block diagram of a gaming machine;

FIG. 3 illustrates a display state of a central liquid crystal panel;

FIG. 4 illustrates a display state of a central liquid crystal panel;

FIG. 5 illustrates a display state of a central liquid crystal panel;

FIG. 6 shows symbols and code numbers thereof;

FIG. 7 illustrates paylines of a central liquid crystal panel;

FIG. 8 is a perspective view showing an external appearance of a slot machine according to a first embodiment;

FIG. 9 is a block diagram showing an electrical structure of a slot machine;

FIG. 10 is a block diagram showing an electrical structure of a graphic board of a slot machine;

FIG. 11 shows a payout management table;

FIG. 12 is a flow chart of a starting process that is executed in a slot machine;

FIG. 13 is a flow chart of an initial process that is executed in a slot machine;

FIG. 14 is a flow chart of a game executing process that is executed in a slot machine; and

FIG. 15 is a perspective view showing an external appearance of a slot machine according to a second embodiment.

### DESCRIPTION OF THE PREFERRED EMBODIMENTS

Hereinafter, a gaming machine according to an embodiment of the invention and a playing method thereof will be described.

A gaming machine 101 (slot machine 1) includes a display area 150 (display windows 151, 152, 153) in which symbols 180 are arranged, a game that awards a payout in accordance with a relation among the symbols arranged and a controller 100 that is programmed to operate as described in the steps of (a1) to (a5).

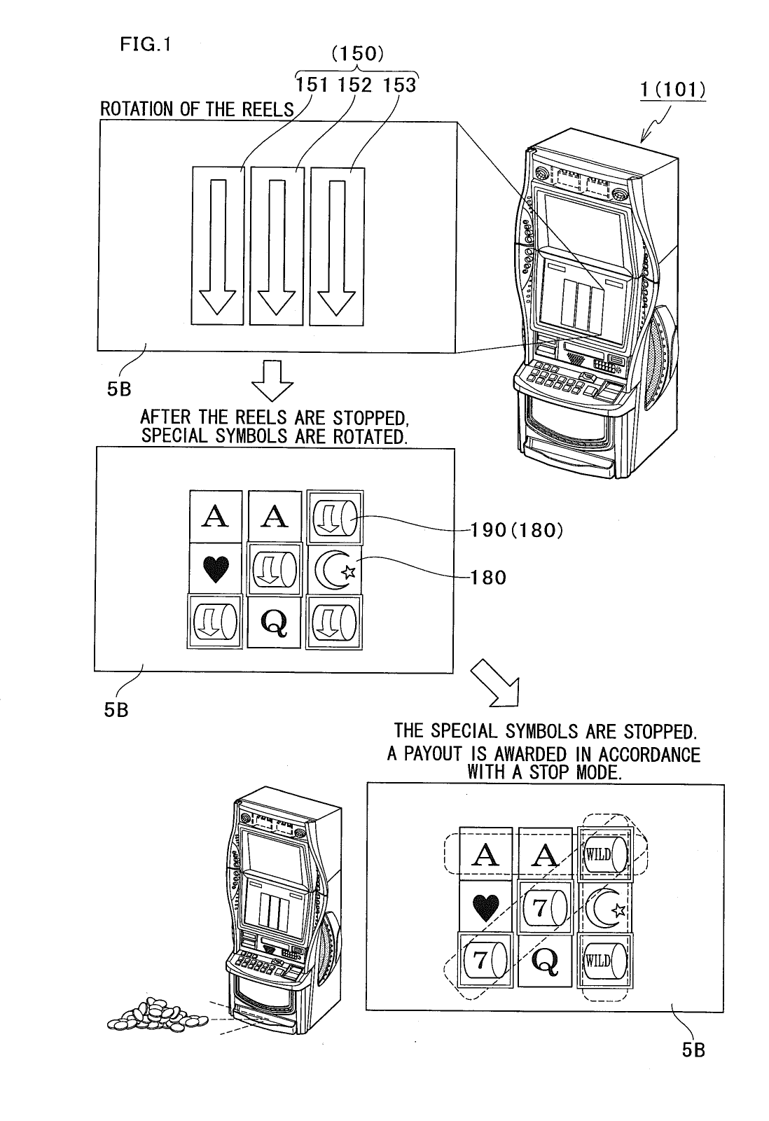

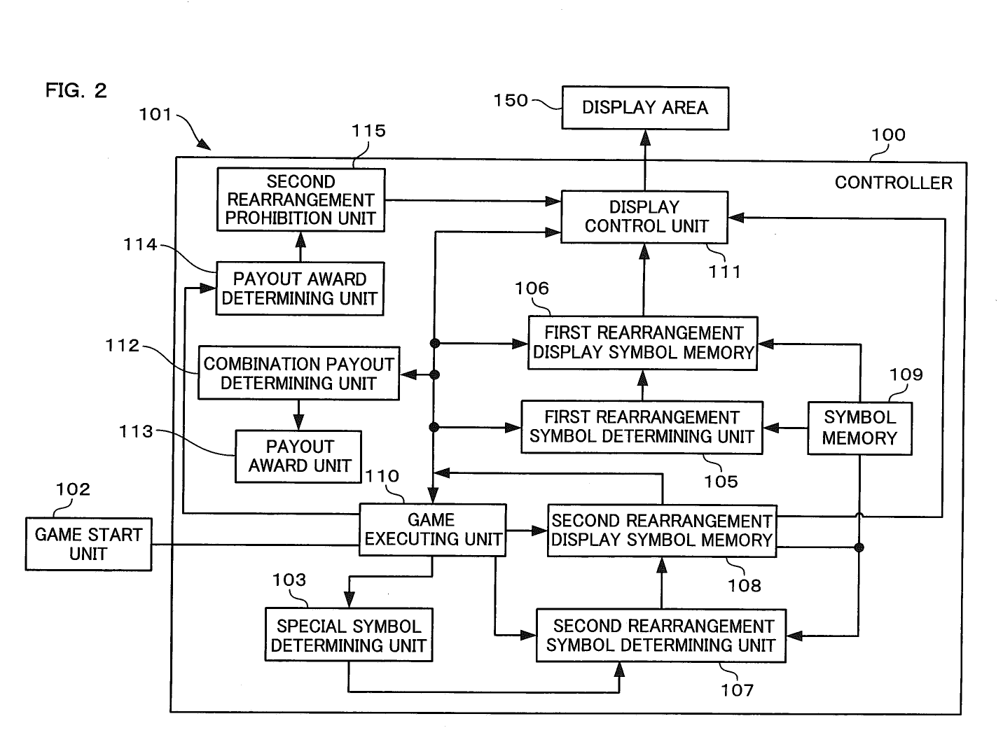

To be more specific, as shown in FIGS. 1 and 2, the gaming machine includes a display area 150 (display windows 151, 152, 153) in which symbols 180 are arranged, a game executing unit 110 that executes a game that awards a payout in accordance with a relation among the symbols 180 arranged, a symbol memory 109 that stores all the symbols 180, a first rearrangement symbol determining unit 105 that determines the symbols 180 to be rearranged on the display area 150, a first rearrangement display symbol memory 106 that stores the symbols 180 determined, a display control unit 111 that rearranges the determined symbols 180 on the display area 150 based on a predetermined timing, a special symbol determining unit 103 that determines whether the symbols 180 stored in the first rearrangement display symbol memory 106 include a special symbol 190, a second rearrangement symbol determining unit 107 that determines the symbols 180 to be rearranged in a second rearrangement when the symbols 180 stored in the first rearrangement display symbol memory 106 include a special symbol 190, a second rearrangement display symbol memory 108 that stores the determined symbols 180, a combination payout determining unit 112 that determines a payout in accordance with a relation among the symbols 180 rearranged, as a result of the first rearrangement and/or the second rearrangement, and a payout award unit 113 that awards the determined payout.

The controller 100 is structured to execute a program to operate as described in the steps of (a1) to (a5). Specifically, in the step of (a1), the controller executes a first rearrangement of rearranging the symbols 180 on the display area 150 (display windows 151, 152, 153), based on a predetermined timing. In the step of (a2), the controller determines whether the symbols 180 rearranged on the display area 150 include a special symbol 190. In the step of (a3), when it is determined that the symbols 180 include a special symbol 190, the controller starts a variable display in the area in which the special symbol 190 is rearranged. In the step of (a4), the controller executes a second rearrangement of rearranging any one of the symbols 180 except the special symbol 190, as a stop mode of the variable display in the area in which the special symbol 190 is rearranged. In the step of (a5), the controller awards a payout in accordance with a relation among the symbols 180 rearranged, as a result of the first rearrangement and/or the second rearrangement.

Thereby, a player who plays a game with the gaming machine 101 (slot machine 1) can expect a payout by a result of the second rearrangement in the same display area 150 as well as a payout by a result of the first rearrangement. Thus, an easy and new entertainment characteristic can be provided.

Here, the “arrangement” means a state in which the symbols 180 are allowed to be visible with naked eyes of an exterior player. In other words, in FIG. 1, it means a state that the symbols 180 are displayed on display windows 151 to 153. In the meantime, the “rearrangement” means arranging the symbols 180 again after dismissing the arrangement of the symbols.

In the meantime, the “gaming machine 101” may be a one player-type or a multiplayer-type. The examples of the multiplayer-type may include a gaming machine that executes a roulette game, a horse race game, a motorboat race game, a bicycle race game and the like, on condition that many players take part in the game. Furthermore, the gaming machines such as slot machine in which one player executes a game are connected to each other in data communication manner, thereby constituting a multiplayer player-type gaming machine.

The gaming machine 101 structured as described above executes a playing method including the steps of: executing a first rearrangement of rearranging the symbols 180 on the display area 150, based on a predetermined timing; determining whether the symbols 180 rearranged on the display area 150 include a special symbol 190; when it is determined that the symbols 180 include a special symbol 190, starting a variable display in the area in which the special symbol 190 is rearranged; executing a second rearrangement of rearranging any one of the symbols 180 except the special symbol 190, as a stop mode of the variable display in the area; and awarding a payout in accordance with a relation among the symbols 180 rearranged, as a result of the first rearrangement and/or the second rearrangement.

Thereby, a player who plays a game with the gaming machine 101 can expect a payout by a result of the second rearrangement in the same display area as well as a payout by a result of the first rearrangement. Thus, an easy and new entertainment characteristic can be provided.

In addition, the gaming machine 101 may be structured to emphasizingly display the special symbol 190 when the special symbol 190 is rearranged. In other words, as shown in FIG. 1, the gaming machine 101 includes a display area 150 of a matrix type having grids in which symbols 180 are respectively arranged; and a controller 100 that is programmed to operate as described in the steps of (b1) to (b5).

In the step of (b1), the controller executes a first rearrangement of rearranging the symbols 180 on the display area 150 (display windows 151, 152, 153), based on a predetermined timing. In the step of (b2), the controller determines whether the symbols 180 rearranged on the display area 150 include a special symbol 190. In the step of (b3), when it is determined that the symbols 180 include a special symbol 190, the controller emphasizingly displays an area of the grid in which the special symbol 190 is rearranged and starts a variable display in the area of the grid. In the step of (b4), the controller executes a second rearrangement of rearranging any one of the symbols 180 except the special symbol 190, as a stop mode of the variable display in the area in which the special symbol 190 is rearranged. In the step of (b5), the controller awards a payout in accordance with a relation among the symbols 180 rearranged, as a result of the first rearrangement and/or the second rearrangement.

Thereby, a player who plays a game with the gaming machine 101 can expect a payout by a result of the second rearrangement in the same display area 150 as well as a payout by a result of the first rearrangement. Thus, an easy and new entertainment characteristic can be provided.

In addition, when a special symbol 190 is rearranged, the grid of the area in which the special symbol is rearranged is emphasizingly displayed. Accordingly, a player can easily fix the eyes on the grid related to a result of the second rearrangement, so that an entertainment characteristic can be increased.

In addition, the gaming machine 101 may be structured not to execute the second rearrangement when there is no possibility of a payout even though the special symbol 190 has been rearranged. In other words, as shown in FIG. 2, the gaming machine 101 may include a payout award determining unit 114 that determines whether there is a possibility that a payout by a second rearrangement is awarded, a second rearrangement prohibition unit 115 that prohibits a variable display in the area in which the special symbol 190 is rearranged when there is no possibility that a payout by a second rearrangement is awarded, and a controller 100 that is programmed to operate as described in the steps of (c1) to (c7).

In the step of (c1), the controller executes a first rearrangement of rearranging the symbols 180 on the display area 150 (display windows 151, 152, 153), based on a predetermined timing. In the step of (c2), the controller determines whether the symbols 180 rearranged on the display area 150 include a special symbol 190. In the step of (c3), when it is determined that the symbols 180 include a special symbol 190, the controller determines whether there is a possibility that the payout is awarded. In the step of (c4), when there is a possibility that the payout is awarded, the controller starts a variable display in the area in which the special symbol 190 is rearranged. In the step of (c5), the controller executes a second rearrangement of rearranging any one of the symbols 180 except the special symbol 190, as a stop mode of the variable display in the area in which the special symbol 190 is rearranged. In the step of (c6), when there is no possibility that the payout is awarded, the controller prohibits the variable display in the area in which the special symbol 190 is rearranged. In the step of (c7), the controller awards a payout in accordance with a relation among the symbols 180 rearranged, as a result of the first rearrangement and/or the second rearrangement.

Thereby, a player who plays a game with the gaming machine 101 can expect a payout by a result of the second rearrangement in the same display area 150 as well as a payout by a result of the first rearrangement. Thus, an easy and new entertainment characteristic can be provided.

In addition, when there is no possibility of a payout even though the second rearrangement has been performed, the second rearrangement is not executed. Accordingly, it is not necessary for a player to see the variable display that is not related to a payout, so that a player's stress can be relieved.

In addition, the gaming machine 101 may be structured to emphasizingly display the special symbol 190 and not to execute the second rearrangement when there is no possibility of a payout even though the special symbol 190 is rearranged. In other words, as shown in FIGS. 1 and 2, the gaming machine may include a display area 150 of a matrix type having grids in which symbols 180 are respectively arranged, a payout award determining unit 114 that determines whether there is a possibility that a payout by a second rearrangement is awarded, a second rearrangement prohibition unit 115 that prohibits a variable display in the area in which a special symbol 190 is rearranged when there is possibility that a payout by a second rearrangement is awarded, and a controller 100 that is programmed to operate as described in the steps of (d1) to (d7).

In the step of (d1), the controller executes a first rearrangement of rearranging the symbols 180 on the display area 150 (display windows 151, 152, 153), based on a predetermined timing. In the step of (d2), the controller determines whether the symbols 180 rearranged on the display area 150 include a special symbol 190. In the step of (d3), when it is determined that the symbols 180 include a special symbol 190, the controller determines whether there is a possibility that the payout is awarded. In the step of (d4), when there is a possibility that the payout is awarded, the controller emphasizingly displays an area of the grid in which the special symbol 190 is rearranged and starts a variable display in the area of the grid. In the step of (d5), the controller executes a second rearrangement of rearranging any one of the symbols 180 except the special symbol 190, as a stop mode of the variable display in the area in which the special symbol 190 is rearranged. In the step of (d6), when there is no possibility that the payout is awarded, the controller prohibits the variable display in the area in which the special symbol 190 is rearranged. In the step of (d7), the controller awards a payout in accordance with a relation among the symbols 180 rearranged, as a result of the first rearrangement and/or the second rearrangement.

Thereby, a player who plays a game with the gaming machine 101 can expect a payout by a result of the second rearrangement in the same display area as well as a payout by a result of the first rearrangement. Thus, an easy and new entertainment characteristic can be provided.

In addition, when a special symbol 190 is rearranged, the grid of the area in which the special symbol is rearranged is emphasizingly displayed. Accordingly, a player can easily fix the eyes on the grid related to a result of the second rearrangement, so that an entertainment characteristic can be increased.

In addition, when there is no possibility of a payout even though the second rearrangement has been performed, the second rearrangement is not executed. Accordingly, it is not necessary for a player to see the variable display that is not related to a payout, so that a player's stress can be relieved.

(Display Area 150)

As shown in FIG. 2, the gaming machine 101 that executes the above playing method includes a display area 150, a controller 100 and a game start unit 102 that starts a game by an operation from outside. The display area 150 is structured to arrange the symbols 180. The symbols 180 include symbols 181 to 189 and a special symbol 190.

The display area 150 may be a mechanical structure with a reel device for arranging the symbols 180 by rotation of a reel or electrical structure with a video reel on which an image is displayed for arranging the symbols 180. Further, the display area 150 may be a structure of combining a mechanical structure (reel) and an electrical structure (video reel). The electrical structure may include a liquid crystal display device, a CRT (cathode-ray tube) device, a plasma display device, organic EL (Organic Electro-Luminescence) display device and the like. In addition, the display area 150 is a matrix type having grids in which the symbols are respectively arranged. However, the invention is not limited thereto.

(Structure of the Controller 100)

As shown in FIG. 2, the controller 100 includes a game executing unit 110, a symbol memory 109, a first rearrangement symbol determining unit 105, a first rearrangement display symbol memory 106, a display control unit 111, a special symbol determining unit 103, a second rearrangement symbol determining unit 107, a second rearrangement display symbol memory 108, a combination payout determining unit 112 and a payout award unit 113.

The game executing unit 110 is structured to execute a game that awards a payout in accordance with a relation among the symbols 180 arranged. To be more specific, the game executing unit 103 starts a variable display of the arranged symbols 180 on the display area 150 with an operating signal, as trigger, from the game start unit 102, and then executes a first rearrangement of rearranging the symbols 180 at a timing that a predetermined time has elapsed since the variable display was started. In addition, when a special symbol 190 is rearranged in the first rearrangement, it executes a second rearrangement of rearranging the symbols 180 on the area in which the special symbol 190 is rearranged. In addition, it transmits a control signal to each block of the controller 100, thereby controlling each block.

The symbol memory 109 is structured to store all the symbols 180. It is referred to when determining the symbols 180 to be rearranged in the first and second rearrangements. The first rearrangement symbol determining unit 105 is structured to determine the symbols 180 that are rearranged on the display area 150. The symbols 180 that are determined by the first rearrangement symbol determining unit 105 includes the special symbol 190. The first rearrangement display symbol memory 106 is structured to store therein the symbols 180 determined by the first rearrangement symbol determining unit 105.

The special symbol determining unit 103 determines whether the symbols 180 stored in the first rearrangement display symbol memory 106 include a special symbol 180. The second rearrangement symbol determining unit 107 is structured to determine the symbols 180 that are rearranged in the second rearrangement, when the symbols 180 stored in the first rearrangement display symbol memory 106 include a special symbol 180. The symbols 180 determined by the second rearrangement symbol determining unit 107 do not include a special symbol 190. The second rearrangement display symbol memory 108 is structured to store therein the symbols 180 determined by the second rearrangement symbol determining unit 107.

The display control unit 111 is structured to rearrange the symbols 180, which are respectively determined in the first and second rearrangement. The combination payout determining unit 112 is structured to determine a payout in accordance with a relation among the symbols 180, as a result of the first rearrangement and/or the second rearrangement. The payout award unit 113 is structured to award a payout determined by the combination payout determining unit 112.

In addition, the controller 100 includes a payout award determining unit 114 that determines whether there is a possibility that a payout by the second rearrangement is awarded, and a second rearrangement prohibition unit 115 that prohibits a variable display in the area in which the special symbol 190 is rearranged, when there is no possibility that a payout by the second rearrangement is awarded. However, the invention is not limited thereto.

Each block of the controller 105 may be embodied in hardware or software, as required.

(Operation of the Controller 100)

With the above structure, an operation of the controller 100 will be described. The operation of the controller 100 is such that each structure is executed on the basis of a control signal form the game executing unit 110. When the game start unit 102 is operated, an operating signal is transmitted to the game executing unit 110. The game executing unit 110 starts a game, based on the operating signal received.

Then, the first rearrangement symbol determining unit 105 determines the symbols 180 to be rearranged on the display area 150 in the first rearrangement. To be more specific, the symbols 180 to be respectively rearranged in the grids of the display area 150 are determined from the symbols 180 stored in the symbol memory 109. The determined symbols 180 are transmitted as a signal to the first rearrangement display symbol memory 106. The first rearrangement display symbol memory 106 stores therein the symbols 180 received.

Then, based on a control signal from the game executing unit 110, the display control unit 111 refers to the symbols 180 to be rearranged in the first rearrangement from the first rearrangement display symbol memory 106. The display control unit 111 rearranges the symbols 180 on the display area 150, based on the information referred to.

Then, the game executing unit 110 acquires the symbols 180 rearranged in the first rearrangement, which are stored in the first rearrangement display symbol memory 106, and transmits a control signal including the symbols 180 rearranged to the special symbol determining unit 103. The special symbol determining unit 103 determines whether the symbols 180 rearranged include a special symbol, based on the control signal transmitted.

When the special symbol determining unit 103 determines that a special symbol 190 is included, the payout award determining unit 114 determines, based on the control signal transmitted from the game executing unit 110, whether there is a possibility that a payout is awarded, as a result of the second rearrangement in the area of the special symbol 190.

When there is a possibility that a payout is awarded, the display control unit 111 emphasizingly displays an area of the grid of the display area 150, in which the special symbol 190 is rearranged and starts a variable display in the area of the corresponding grid. Then, based on the control signal from the game executing unit 110, the second rearrangement symbol determining unit 107 determines the symbol 180, as a stop mode of the variable display. As a stop symbol in the second rearrangement, any one except the special symbol 190 is determined. The determined symbol 190 is transmitted as a signal to the second rearrangement display symbol memory 108. The second rearrangement display symbol memory 108 stores therein the symbol 180 received.

Then, based on a control signal from the game executing unit 110, the display control unit 111 refers to the symbol 180 to be rearranged in the second rearrangement from the second rearrangement display symbol memory 108. The display control unit 111 rearranges the symbol 180 on the area of the display area 150, in which the special symbol 190 is rearranged, based on the information referred to.

In the meantime, when there is no possibility that a payout is awarded, the second rearrangement prohibition unit 115 prohibits a variable display in the area of the display area 150, in which the special symbol 190 is rearranged.

After that, as a result of the first rearrangement and/or the second rearrangement, a payout is awarded in accordance with a relation among the symbols 180 rearranged.

### First Embodiment

In the followings, a first embodiment of the invention will be described with reference to FIGS. 1 to 15.

(Display State)

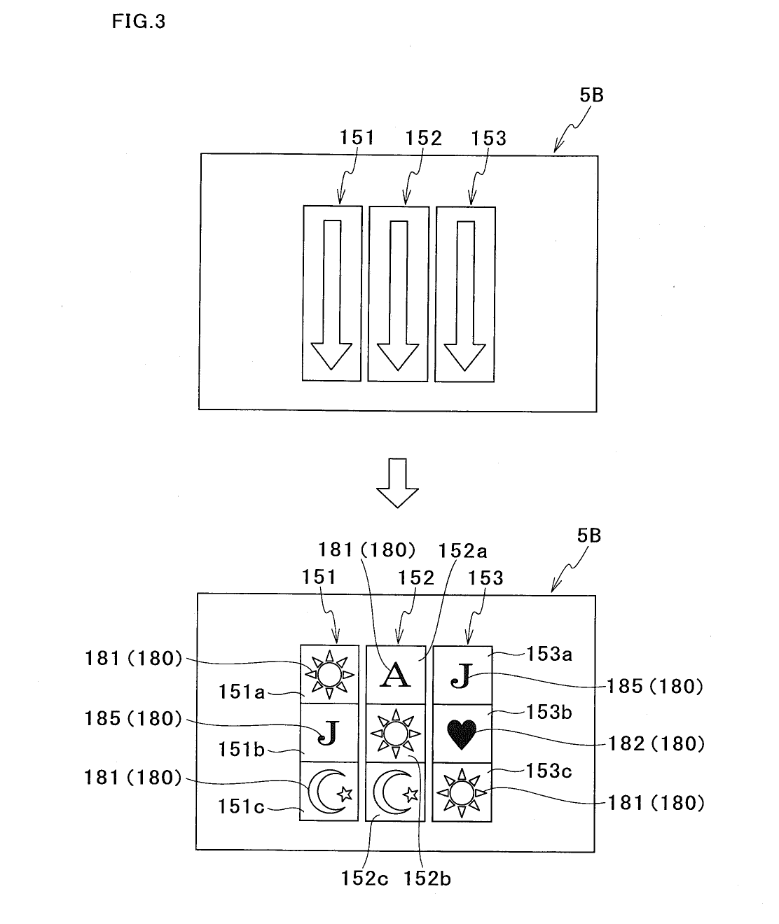

An example will be described in which the gaming machine 101 is applied to a slot machine 1. FIGS. 3 to 5 illustrate an example of a display state on the display windows 151, 152, 153 on the central liquid crystal panel 5B in the slot machine 1 and the playing method thereof. Meantime, in this embodiment, the central liquid crystal panel 5B arranges the symbols 180 in a video reel manner.

As shown in FIG. 3, the central liquid crystal panel 5B has display windows 151 to 153 that arrange the symbols 180. The display windows 151 to 153 are arranged in a center of the central liquid crystal panel 5B. A game of the slot machine 1 according to this embodiment executes a first rearrangement and a second rearrangement in the display windows 151 to 153. In the first rearrangement, a symbol column consisting of the symbols 180 is scrolled in the display windows 151 to 153 (see the top of FIG. 3). In addition, the respective display windows 151 to 153 are divided into upper stages 151a, 152a, 153a, central stages 151b, 152b, 153b and lower stages 151c, 152c, 153c, as shown in the bottom of FIG. 3. The symbols 180 are respectively stopped (arranged) in the respective stages 151a to 153a, 151b to 153b, 151c to 153c. For example, in FIG. 3, a symbol of “SUN” 181 is stopped in the upper stage 151a of the display window 151, a symbol of “SUN” 181 is stopped in the central stage 152b of the display window 152 and a symbol of “SUN” 181 is stopped in the lower stage 153c of the display window 153. Thereby, the display windows 151 to 153 display a symbol matrix consisting of 3 columns/3 rows. In other words, the display windows 151 to 153 consist of a matrix type having nine grids. In the meantime, the symbol matrix is not limited to 3 columns/3 rows.

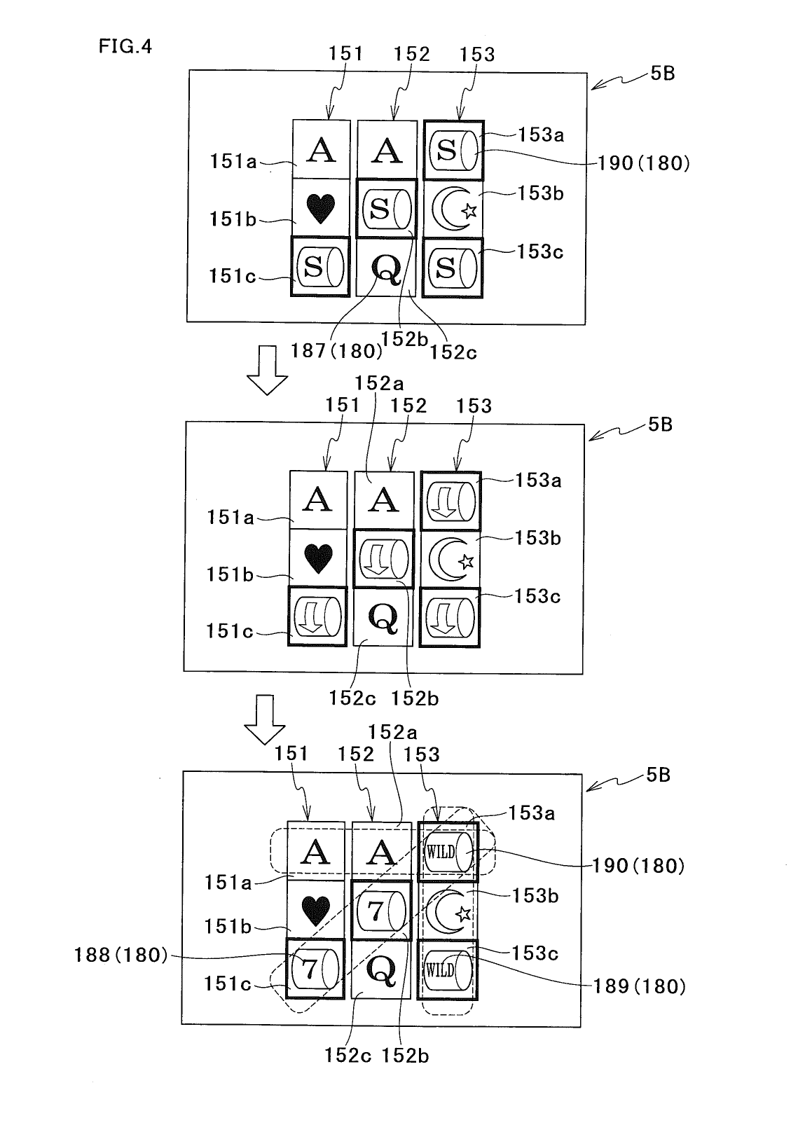

In addition, the second rearrangement is executed when a special symbol 190 is rearranged on the display windows 151 to 153 as a result of the first rearrangement. To be more specific, as shown in the top of FIG. 4, when the special symbols 190 are rearranged by the first rearrangement, the contour lines of the grids in which the special symbols 190 are rearranged are emphasizingly displayed in a thicker line than those of the other grids. In other words, the areas in which the special symbols 190 are rearranged are emphasizingly displayed, so that a player can fix the eyes on the grids in which the second rearrangement is executed.

Then, as shown in the center of FIG. 4, a variable display is started in the grids in which the special symbols 190 are rearranged. Here, the special symbol 190 is a design showing a cylinder having a horizontal axis and a letter of “S” depicted on a side thereof. The variable display in the girds in which the special symbols 190 are rearranged is such shown that the cylinders are scrolled. In the meantime, the design of the special symbol 190, the emphasizing display of the grids in which the special symbols 190 are rearranged and the variable display in the grids in which the special symbols 190 are rearranged are not limited to the above.

Then, as shown in the bottom of FIG. 4, as a stop mode of the variable display in the grids in which the special symbols 190 are rearranged, a second rearrangement is executed in which any one of the symbols 180 except the special symbol 190 is rearranged. For example, in the bottom of FIG. 4, a symbol of “7” 188 is stopped on the lower stage 151c of the display window 151, a symbol of “7” 188 is stopped on the central stage 152b of the display window 152, a symbol of “WILD” 189 is stopped on the upper stage 153a of the display window 153 and a symbol of “WILD” 189 is stopped on the lower stage 153c of the display window 153. In addition, in this embodiment, although the symbols of “7” 188 and “WILD” 189 are rearranged by the second rearrangement, the invention is not limited thereto. For example, any one of all the symbols except the special symbol 190 of the symbols 180 may be rearranged.

As a result of the first rearrangement and/or the second rearrangement, it is determined whether a winning combination is made in accordance with a relation among the symbols 180 rearranged, and a payout is awarded to a player. Meantime, the winning combination will be described later.

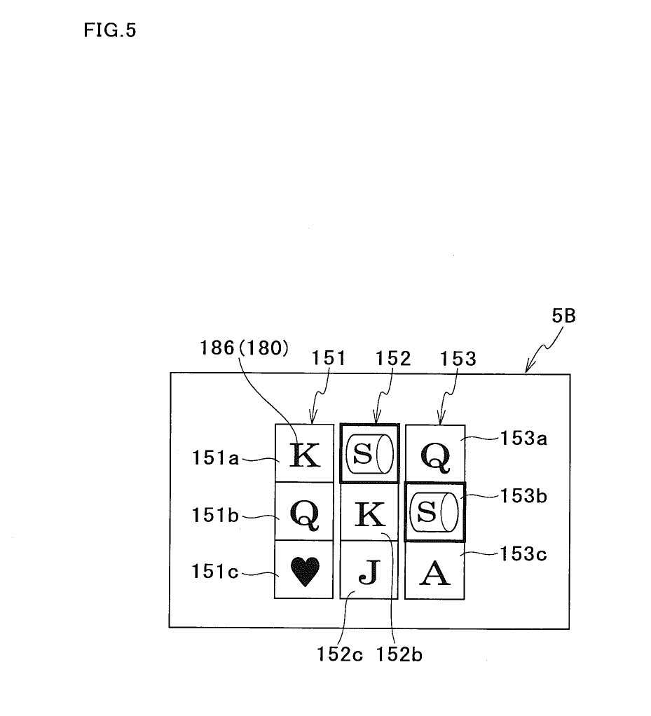

In addition, as shown in FIG. 5, when there is no possibility that a payout is awarded to a player because a winning combination is not made even though the special symbols 190 are rearranged, a variable display in the grids in which the special symbols 190 are rearranged is not started. Like this, when there is no possibility that a payout is awarded, a second rearrangement is not executed, so that it is not necessary for a player to see a variable display that is not related to a payout. Accordingly, a player's stress can be relieved.

(Symbol, Winning Combination and the Like)

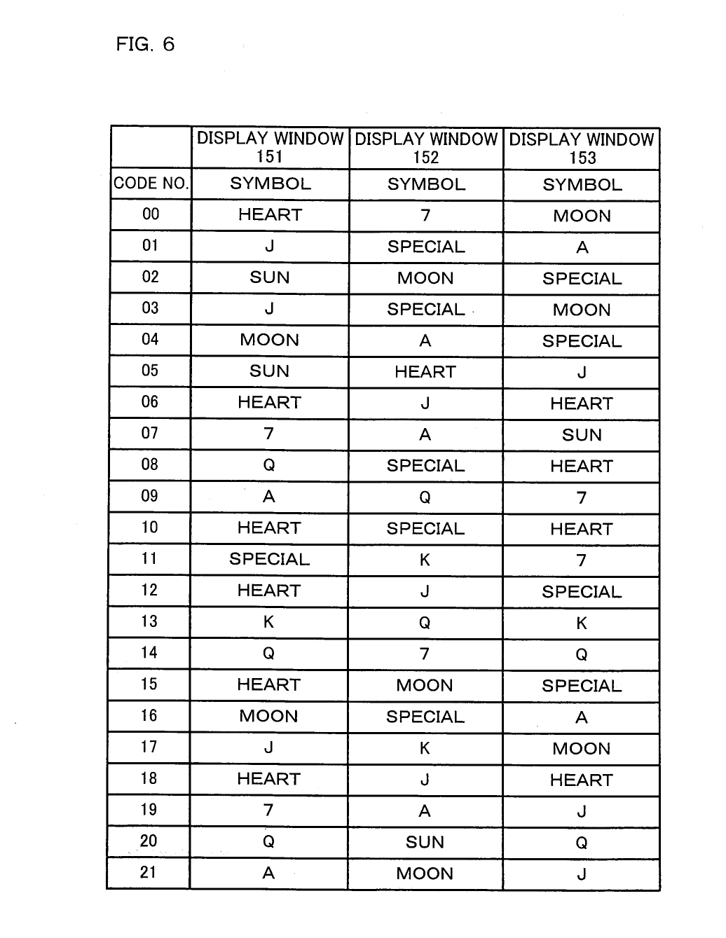

As shown in FIG. 6, the symbols 180 to be displayed on the display windows 151 to 153 of the central liquid crystal panel 5B by the first rearrangement constitute the symbol columns by 22 symbols. The symbols constituting the respective symbol columns are given with one code number of 0˜21, respectively. Each of the symbol columns is constituted with a combination of picture symbols of “SUN” 181, “HEART” 182 and “MOON” 183 and letter symbols of “A” 184, “J” 185, “K” 186, “Q” 187 and “7” 188. Meantime, a symbol of “7” 188 or a letter symbol of “WILD” 189 that is not included in the above symbol columns is rearranged by the second rearrangement.

In addition, for each symbol 180, various winning combinations are determined in advance. The winning combination is such a combination that a combination of symbols 180 stopped on the payline 160 allows an advantageous state to a player. The advantageous state is a state in which a coin is paid out as a payout in accordance with the winning combination, a state in which the payout-number of coins is added to the credit, a state in which a bonus game is started, and the like.

In the meantime, the bonus game is a gaming state that is more advantageous than a base game. In this embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the base game. For example, the bonus game may include a state in which it is possible to obtain more game media than the base game, a state in which it is possible to obtain a game medium in a higher probability than in the base game, a state in which a game medium is less consumed than in the base game, and the like. Specifically, a free game, a second game, a feature game and the like are examples of the bonus game.

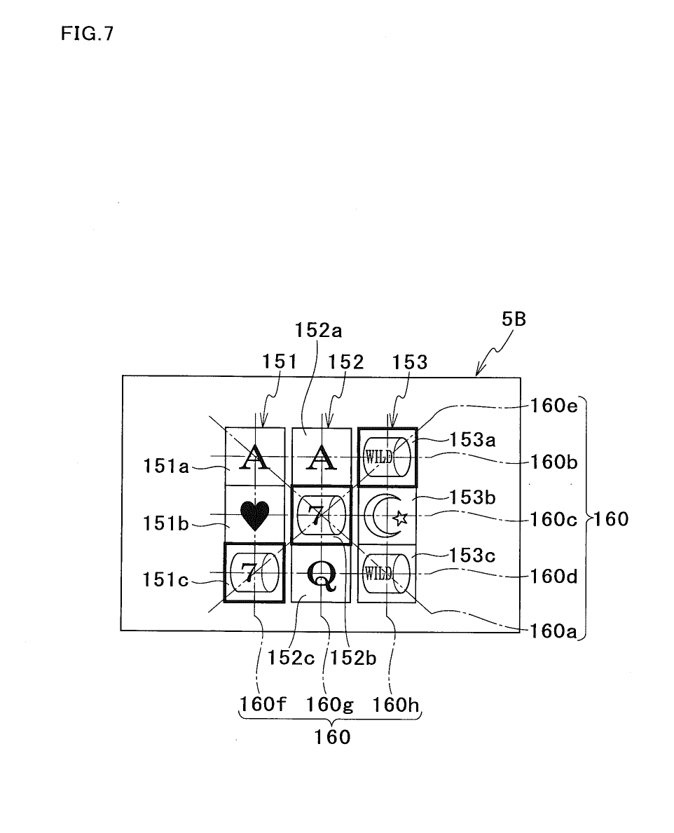

A winning combination is made by the symbols 180 that are stopped on the payline 160 set on the display windows 151 to 153. As shown in FIG. 7, the payline 160 includes a horizontal top line 160b, a horizontal center line 160c and a horizontal bottom line 160d, each of which horizontally traverses the three symbols 180 arranged vertically, a cross down line 160a and a cross up line 160e, each of which diagonally traverses, and a vertical left line 160f, a vertical center line 160g and a vertical right line 160h, each of which vertically traverses the three symbols 180 arranged vertically. When the same symbols 180 are rearranged on the paylines 160a to 160h, a winning combination is made.

Here, a letter symbol of “WILD” 189 is a symbol that substitutes any symbol 180. For example, as shown in FIG. 7, when a symbol of “7” 188 is rearranged on the lower stage 151c of the display window 151, a symbol of “7” 188 is rearranged on the central stage 151b of the display window 152 and a symbol of “WILD” 189 is rearranged on the upper stage 153a of the display window 153, the symbol of “WILD” 189 becomes a substitute for the symbol of “7” 188, so that a winning combination of “7” is made on the cross up line 160e of the payline 160. In addition, in an example of the rearrangement of FIG. 7, a winning combination of “A” is made on the horizontal top line 160b and a winning combination of “MOON” is made on the vertical right line 160h.

In the meantime, the invention is not to limited to the case where a winning combination is made based on the symbols 180 on the payline 160. For example, each of the symbols 180 may be set as a scatter symbol. To be more specific, it may be possible that when a predetermined number or more of the scatter symbols are displayed on the display windows 151 to 153, a winning combination is made and a gaming state becomes advantageous to a player.

(Mechanical Structure: Schematic Structure)

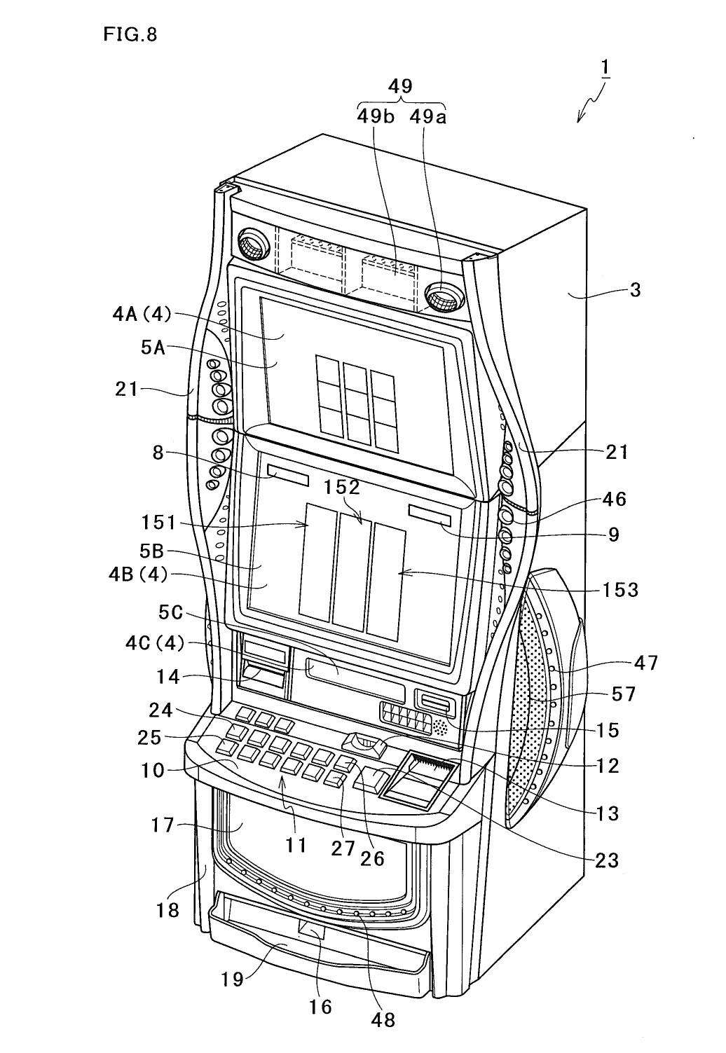

FIG. 8 is an external perspective view showing an outlined structure of the slot machine 1 according to this embodiment. The slot machine 1 is an upright-type slot machine provided in a game arcade such as casino and the like. The slot machine 1 has a cabinet 3 for receiving electrical or mechanical parts so as to execute a game aspect. The cabinet 3 has a shape that is longitudinally long. As a display unit 4 for displaying the game information based on a game operation of a player, there are provided an upper variable display unit 4A, a central variable display unit 4B and a lower variable display unit 4C, for example. Each of the display units 4A, 4B, 4C is attached to a front of the cabinet 3 that is longitudinally long.

The upper variable display unit 4A is a display unit on which a player fixes the eyes during the unit game and has a transparent upper liquid crystal panel 5A that is fixed to a front door of the cabinet 3. A variety of effect images are displayed in the upper liquid crystal panel 5A during the unit game. For example, an effect of a moving picture is performed in the upper liquid crystal panel 5A when a winning is made, for example.

The central variable display unit 4B is a rotating symbol display panel on which a player always fixes the eyes and has a transparent central liquid crystal panel 5B that is fixed to the front door of the cabinet 3. To the central liquid crystal panel 5B are provided three display windows 151 to 153 as a display area in which the symbols 180 are arranged. Moreover, a payout-number display unit 8 and a credit-number display unit 9 are displayed in an upper part of the central liquid crystal panel 5B. In the meantime, a display state of the display windows 151 to 153 that are displayed on the central liquid crystal panel 5B will be specifically described later.

The lower variable display unit 4C has a lower liquid crystal panel 5C that displays a point-number recorded in a card or a point-number of a game. A numerical value displayed in the lower liquid crystal panel 5C is based on a display result of the central variable display unit 4B. When a winning combination is made in the central variable display unit 4B, a point-number of a game displayed in the lower liquid crystal panel 5C is added on the basis of the winning combination made. A ticket printer 14 is provided to a left side of the lower liquid crystal panel 5C and a card reader 15 is provided to a right side of the lower liquid crystal panel 5C.

An operating table 10 that protrudes forward from the front face of the cabinet 3 is disposed below the lower variable display unit 4C. On the operating table 10, there are arranged operating buttons 11 as an operating unit enabling a player to operate a game. To be more specific, the operating buttons 11 include a start button 23, a change button 24, a cashout button 25, a 1-BET button 26 and a MAX-BET button 27. In addition, a coin insertion slot 12 and a bill insertion slot 13 are provided to the operating table 10.

The start button 23 is a button for inputting an instruction to start a variable display (scroll) of symbols. The change button 24 is a button to be used when a player asks a staff in the game arcade for exchange of money. The cashout button 25 is a button for inputting an instruction to pay out the coins of total credit-number into a coin receiving portion 19.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

A waist-position panel 17 is disposed below the operating table 10. The waist-position panel 17 is a plastic panel having a game-related image printed thereto. The waist-position panel 17 is fixed to a lower front door 18 and illuminated by a cold cathode-ray tube. In addition, a coin receiving portion 19 that collects coins, which are paid out on the basis of a game result, is disposed below the waist-position panel 17.

Furthermore, a light-emitting unit 56 is disposed to the cabinet 3 of the slot machine 1 so that it surrounds a game area including the upper variable display unit 4A, the central variable display unit 4B, the lower variable display unit 4C and the operating table 10. The light-emitting unit 56 comprises side lamps 46 that are provided to inclined parts 21, which are protruded in a bow shape at front right and left ends of the cabinet 3 and at side parts over the upper variable display unit 4A, the central variable display unit 4B and the lower variable display unit 4C, speaker lamps 47 that are provided to arc-shaped speaker 57, which are sideways protruded at the right and left ends of the cabinet 3 adjacent to the operating table 10, and are arranged along edges of the speakers 57, under lamps 48 that are provided to a lower front door 18 and arranged along lower edges of the waist-position panel 17, and top lamps 49 that are provided to an upper part of the upper variable display unit 4A and have power lamps 26a disposed at both sides and central band-shaped lamps 49b arranged in a horizontal direction.

(Electrical Structure of the Slot Machine 1)

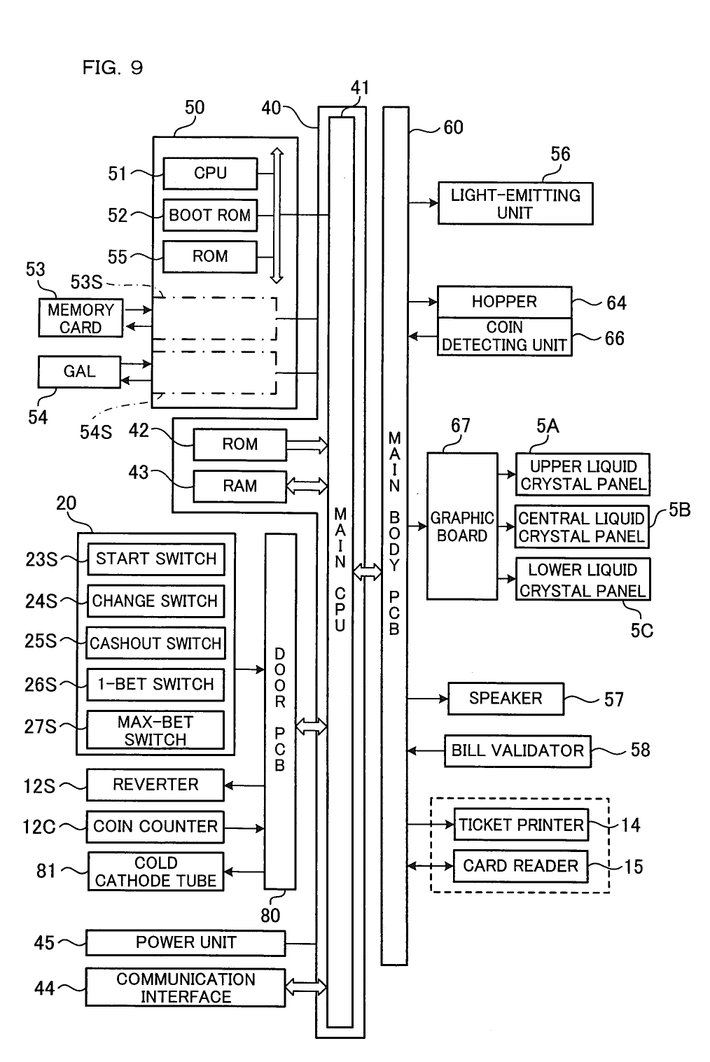

FIG. 9 is a block diagram showing an entire electrical structure of the slot machine 1. A control unit having the game controller 100 illustrated in FIG. 2 is mounted in the cabinet 3. As illustrated in FIG. 9, the control unit comprises a motherboard 40, a main body PCB (Printed Circuit Board) 60, a gaming board 50, a sub CPU 61, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol (code number corresponding to the symbol) to be stopped on the payline. The stop symbol determining program includes symbol weight data corresponding to each of plural payout rate (for example, 80%, 84%, 88%). The symbol weight data is data representing a correspondence relation between the code number of each symbol and 1 or plural random numbers belonging to a predetermined numerical range (0-256) for each of the display windows 151 to 153.

In addition, the memory card 53 stores a program that samples a random number. When a game executing process, a bonus game process and the like are executed, the random number sampling program is read to the RAM 43 and is executed by the main CPU 41. In this embodiment, a random number sampling is executed by a program. However, the invention is not limited thereto. For example, it may be provided a random number generator that generates a random number within a predetermined range and a sampling circuit that samples any number from the random numbers generated by the random number generator 35.

The payout rate is determined on the basis of data for setting a payout rate, which data is outputted from the GAL 54, and a stop symbol is determined on the basis of the symbol weight data corresponding to the payout rate.

Further, the memory card 53 stores various data used for the game program and the game system program. For example, the data, which represents a relationship between the symbols 180 displayed on the display windows 151 to 153 of FIG. 1 and the code numbers, is stored in a data table form. Further, these data are transmitted to a RAM 43 of the motherboard 40 when executing the game program.

In addition, the card slot 53S is structured to insert and remove the memory card 53 and connected to the motherboard 40 through an IDE bus. Thereby, as a change process having the steps of removing the memory card 53 from the card slot 53S, writing another game program and game system program into the memory card 53 and inserting the memory card 53 into the card slot 53S is executed, the gaming board 50 can change the types or contents of a game that is executed in the slot machine 1.

The game program includes a program relating to a game progress and a program for shifting a gaming state to a bonus game.

The GAL 54 is provided with plural input and output ports. When the data is inputted into the input ports, the GAL 54 outputs data corresponding to the inputted data from the output ports. The data outputted from the output ports is the data for setting a payout rate that has been described above.

The IC socket 54S is structured to attach and detach the GAL 54. The IC socket 54S is associated with the motherboard 40 through a PCI bus. Accordingly, it is possible to change the data for setting a payout rate that is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are associated with each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication interface 44.

The main CPU 41 has functions of a controller for controlling the whole slot machine 10. In particular, the main CPU 41 carries out a control for outputting a command signal enabling the graphic board 67 to start a variable display in the display windows 151 to 153 when the start button 23 is pushed after a credit is bet, a control for determining symbols to be stopped after the variable display is started and a control for stopping the determined symbols on the display windows 151 to 153.

In other words, the main CPU 41 has functions of an arrangement controller for selecting and determining arrangement symbols with regard to a symbol matrix from the plural types of symbols so as to rearrange them, as a new symbol matrix after scrolling the plural symbols to be displayed on the central liquid crystal panel 5B, and executing an arrangement control of the first rearrangement which will be stopped at the determined symbols from the scroll state.

To be more specific, the main CPU 41 functions as a controller 100 that executes a process of executing a first rearrangement of rearranging the symbols 180 on the display area 150 (display windows 151, 152, 153), based on a predetermined timing; a process of determining whether the symbols 180 rearranged on the display area 150 include a special symbol 190; a process of when it is determined that the symbols 180 include a special symbol 190, determining whether there is a possibility that a payout is awarded; a process of when there is a possibility that a payout is awarded, emphasizingly displaying an area of a grid in which the special symbol 190 is rearranged and starting a variable display in the area; a process of executing a second rearrangement of rearranging any one of the symbols 180 except the special symbol 190, as a stop mode of the variable display in the area in which the special symbol 190 is rearranged; a process of when there is no possibility that a payout is awarded, prohibiting the variable display in the area in which the special symbol 190 is rearranged; and a process of awarding a payout in accordance with a relation among the symbols 180 rearranged, as a result of the first rearrangement and/or the second rearrangement.

The ROM 42 stores a program such as BIOS (Basis Input/Output System) to be executed by the main CPU 41, and data that is permanently used. When the BIOS is executed by the main CPU 41, each of peripheral devices is initialized and the game program and the game system program stored in the memory card 53 are read out through the gaming board 50. The RAM 43 stores the data or program that is used when the main CPU 41 carries out a process.

The communication interface 44 is provided to communicate with a host computer and the like through a communication line, which are mounted in the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are associated with a device or apparatus for producing an input signal that is inputted to the main CPU 41, and a device or apparatus that is controlled by the control signal outputted from the main CPU 41. The main CPU 41 executes the game program and the game system program stored in the RAM 43, based on the input signal inputted to the main CPU 41. Thereby, the main CPU 41 executes a process of carrying out an arithmetic process and storing a result thereof in the RAM 43, a process of transmitting a control signal to each device or apparatus as a process of controlling each device or apparatus, and the like.

The main body PCB 60 is associated with a light-emitting unit 56, a hopper 64, a coin detection unit 66, a graphic board 67, a speaker 57, a bill validator 58, a ticket printer 14 and a card reader 15. The light-emitting unit 56 consists of the lamps including the side lamps 46, the speaker lamps 47, the under lamps 48 and the top lamps 49 or LEDs.

The turning on and off of the light-emitting unit 56 is controlled, based on a control signal outputted from the main CPU 41. The hopper 64 is mounted in the cabinet 3 and pays out a predetermined number of coins to the coin receiving portion 19 from the coin payout slot 19, based on the control signal outputted from the main CPU 41. The coin detection unit 66 is mounted in the coin payout slot 16, and outputs an input signal to the main CPU 41 when it detects that a predetermined number of coins are paid out from the coin payout slot 16.

The coin detection unit 66 measures the number of coins paid out by the hopper 64 and inputs data of the measured number to the main body PCB 60. The main body PCB 60 outputs, based on the data of the measured number inputted, to the main CPU 41 a signal to notify the payout completion of the coins when it reaches a payout-number set.

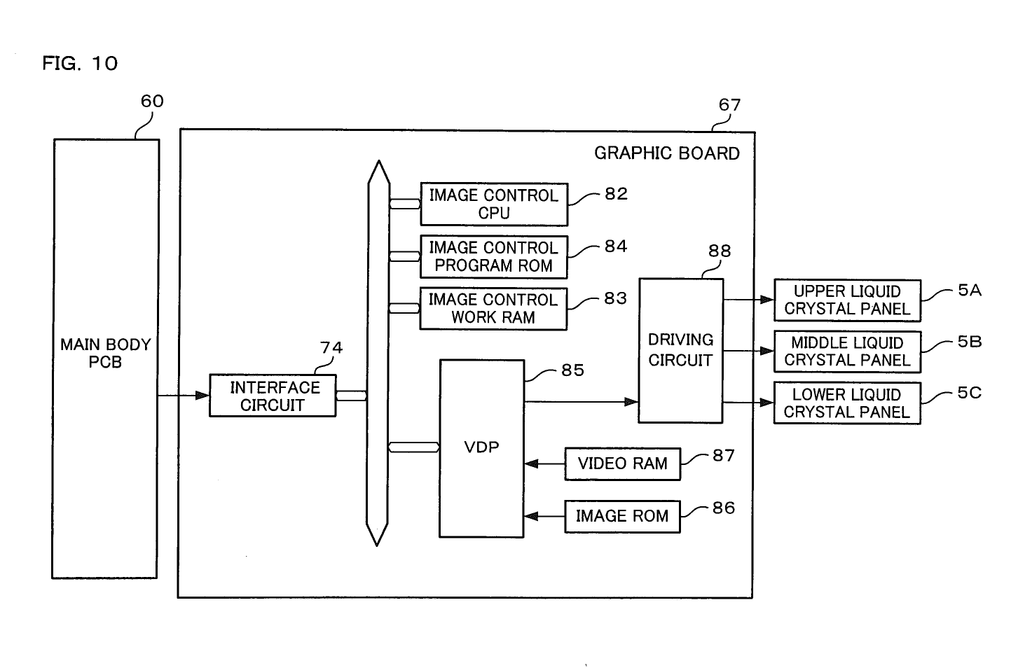

The graphic board 67 controls an image display in the upper liquid crystal panel 5A, the central liquid crystal panel 5B and the lower liquid crystal panel 5C, based on a control signal outputted from the main CPU 41. As shown in FIG. 10, the graphic board 67 has an interface circuit 81, an image control CPU 82, an image control work RAM 83, an image control program ROM 84, a VDP (Video Display Processor) 85, an image ROM 86, a video RAM 87 and a driving circuit 88.

The image control CPU 82 receives a control signal outputted from the main CPU 41 through the interface circuit 81. In addition, based on the control signal from the main CPU 41, it determines an image that is displayed in the upper liquid crystal panel 5A, the central liquid crystal panel 5B and the lower liquid crystal panel SC, in accordance with the image control program stored in the image control program ROM 84.

The image control program ROM 84 stores an image control program that is related to a display in the upper liquid crystal panel 5A, the central liquid crystal panel 5B and the lower liquid crystal panel 5C, or various selection tables. The image control work RAM 83 is structured to serve as a temporary memory means when the image control program is executed in the image control CPU 82.

The VDP 85 forms image data relating to the contents determined in the image control CPU 82. The image ROM 86 stores dot data for forming an image such as the symbols 180 and the like. The video RAM 87 serves as a temporary memory means when an image is formed in the VDP 85. The driving circuit 88 outputs the image data formed by the VDP 85 to the upper liquid crystal panel 5A, the central liquid crystal panel 5B and the lower liquid crystal panel 5C. Meantime, the image data that is used when generating the image data by the VDP is stored in the memory card 53 and is included in the game program that is read out from the memory card 53 and is temporarily stored in the RAM 43.

As shown in FIG. 9, the speaker 57 outputs a variety of effect sounds when various effects are carried out on the basis of an output signal from the main body PCB 60. The bill validator 58 reads an image of bill inserted into the bill insertion slot 13 and receives the normal bill in the cabinet 3. In addition, when receiving the normal bill, the bill validator 58 outputs an input signal to the main CPU 41 based on an amount of the bill. The main CPU 41 stores a credit-number in the RAM 43, which corresponds to the amount of bill transmitted by the input signal.

The ticket printer 14 prints a barcode on a ticket, in which data such as credit-number stored in the RAM 33, the day and time and identification number of the slot machine 1 is coded, based on the control signal outputted from the main CPU 41, and then outputs a ticket having the barcode attached thereto.

The card reader 15 reads the data from a smart card to transmit it to the main CPU 41, or writes the data to the smart card based on a control signal from the main CPU 41.

The door PCB 80 is associated with a control panel 20, a reverter 12S, a coin counter 12C and a cold cathode tube 89. The control panel 20 is provided with a start switch 23S corresponding to the start button 23, a change switch 24S corresponding to the change button 24, a cashout switch 25S corresponding to the cashout button 25, a 1-BET switch 26S corresponding to the 1-BET button 26 and a MAX-BET switch 27S corresponding to the MAX-BET button 27. Each of the switches 23S to 27S outputs an input signal to the main CPU 41 when each of the corresponding buttons 23 to 27 is operated by a player.

The coin counter 12C is mounted in the coin insertion slot 12 and validates whether a coin, which is inserted in the coin insertion slot 21 by the player, is normal or not. A coin except the genuine coin is discharged from the coin payout slot 16. In addition, the coin counter 12C outputs an input signal to the main CPU 41 when it detects a genuine coin.

The reverter 12S is operated on the basis of the control signal outputted from the main CPU 41 and distributes a coin, which is recognized as a normal coin by the coin counter 12C, to a cash box (not shown) or hopper 64 mounted in the slot machine 10. In other words, when the hopper 64 is fully filled with the coins, the normal coin is distributed into the cash box by the reverter 12S. In the mean time, when the hopper 64 is not fully filled with the coins, the genuine coin is distributed into the hopper 64. The cold cathode tube 89 functions as a backlight mounted to rear sides of the upper liquid crystal panel 5A, the central liquid crystal panel 5B and the lower liquid crystal panel 5C and is turned on, based on the control signal outputted from the main CPU 41.

(Data Table)

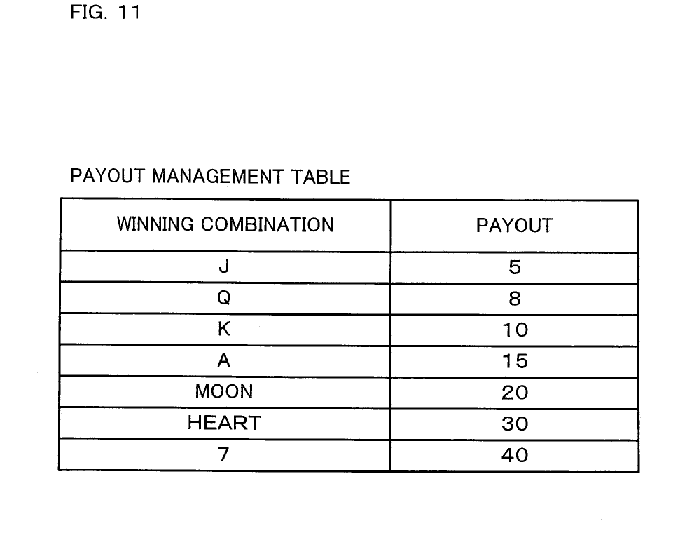

Based on FIG. 11, a payout management table will be described. The payout management table is stored in the memory card 53 and is read out into the RAM 43 by the main CPU 41. The payout management table is referred to when a winning combination is made and a payout is thus awarded to a player in the first rearrangement and/or the second rearrangement.

The payout management table has a column of winning combinations and a column of payouts. The column of winning combinations stores symbols that enable a payout to be awarded to a player when a winning combination is made. The column of payouts stores payouts per 1 BET, which correspond to the symbols that enable a payout to be awarded.

To be more specific, when a symbol of “J” 185 is stopped on the payline 160, 5 coins (game media) per 1 BET are paid out. In addition, when a symbol of “Q” 187 is stopped on the payline 160, 8 coins per 1 BET are paid out. In addition, when a symbol of “K” 186 is stopped on the payline 160, 10 coins per 1 BET are paid out. In addition, when a symbol of “A” 184 is stopped on the payline 160, 15 coins per 1 BET are paid out. In addition, when a symbol of “MOON” 183 is stopped on the payline 160, 20 coins per 1 BET are paid out. In addition, when a symbol of “HEART” 182 is stopped on the payline 160, 30 coins per 1 BET are paid out. In addition, when a symbol of “7” 188 is stopped on the payline 160, 40 coins per 1 BET are paid out. In addition, when a combination of “SUN” 181 is stopped on the payline 160, a bonus trigger is made, so that a gaming state is shifted to a bonus game from a basic game. Meantime, the payout contents such as the number of coins to be paid out are not limited to the above.

(Processing Operation of the Slot Machine 1)

In the followings, a process that is executed in the slot machine 1 will be described. After the main CPU 41 carries out a starting process, the main CPU 41 reads out the game program stored in the memory card 53, so that a game is progressed.

(Processing Operation of the Gaming Machine 1: Starting Process)

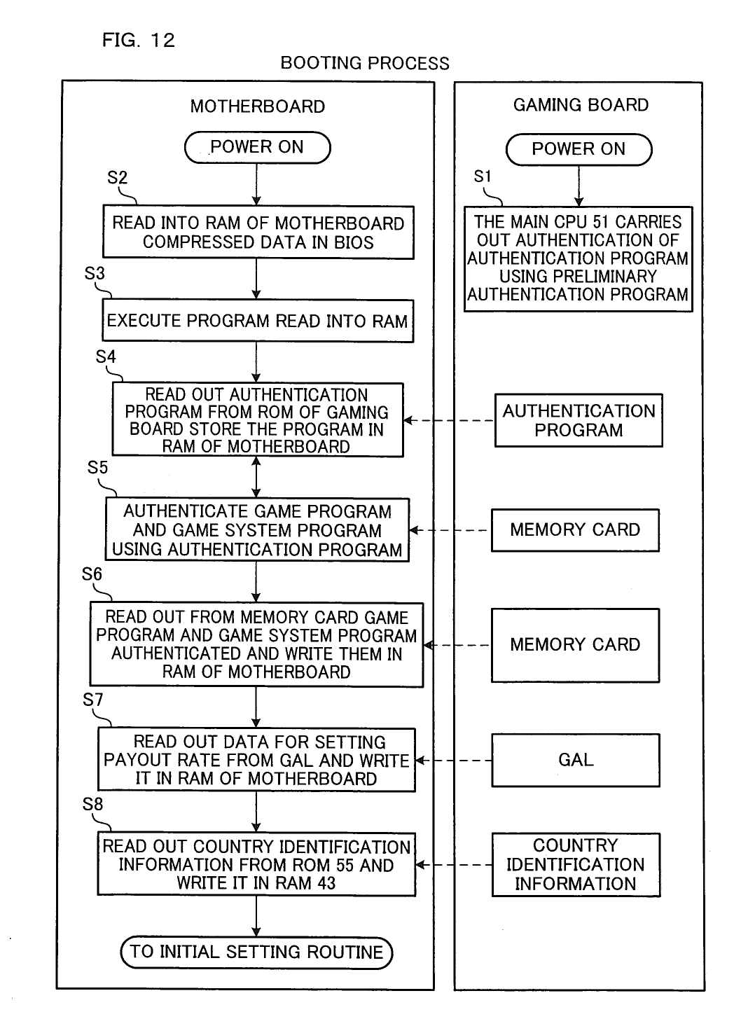

When power is supplied, the main CPU 41 of the slot machine 1 executes a starting process routine shown in FIG. 12. The starting process is a process that is executed by the motherboard 40 and the gaming board 50. Meantime, it is assumed that the memory card 53 is inserted in the card slot 53S and the GAL 54 is attached to the IC socket 54S in the gaming board 50.

First, when power is supplied in a power unit 45, the motherboard 40 and the gaming board 50 are started. When the main control board 40 and the gaming board 50 are started, separate processes are carried out in parallel, respectively. In other words, in the gaming board 50, the CPU 51 reads out the preliminary authentication program stored in the boot ROM 52 and performs a preliminary authentication of confirming and verifying in advance that the authentication program is not falsified before it is loaded to the main control board 71 (S1). In the meantime, in the motherboard 40, the main CPU 41 executes the BIOS stored in the ROM 42 and develops the compressed data, which is incorporated in the BIOS, into the RAM 43 (S2). Then, the main CPU 41 executes the BIOS developed into the RAM 33 to check and initialize the operations of the various peripheral devices (S3).

The main CPU 41 is associated with the ROM 55 of the gaming board 50 via the PCI bus. The main CPU 41 reads out the authentication program stored in the ROM 55 and stores the authentication program read in the RAM 43 (S4). At this time, the main CPU 41 takes a check sum by an ADDSUM manner (standard check function) in accordance with a standard BIOS function of the BIOS, confirms whether the storing is positively carried out and stores the authentication program in the RAM 33.

Then, the main CPU 41 confirms what is associated with the IDE bus, accesses the memory card 53 inserted in the card slot 53S through the IDE bus and reads out the game program and the game system program from the memory card 53. In this case, the main CPU 41 reads out the data constituting the game program and the game system program, by four bytes. Continuously, the main CPU 41 performs an authentication of confirming and verifying that the game program and the game system program read are not falsified in accordance with the authentication program stored in the RAM 43 (S5).

When the authentication process is normally ended, the main CPU 41 writes and stores the game program and the game system program, which are authentication objects (i.e., which are authenticated), in the RAM 43 (S6).

Then, the main CPU 41 accesses the GAL 54 attached to the IC socket 54S through the PCI bus, reads out the data for setting a payout rate and writes and stores it in the RAM 43 (S7).

Then, the main CPU 41 reads out country identification information stored in the ROM 55 of the gaming board 50 through the PCI bus and stores the country identification information read in the RAM 43 (S8).

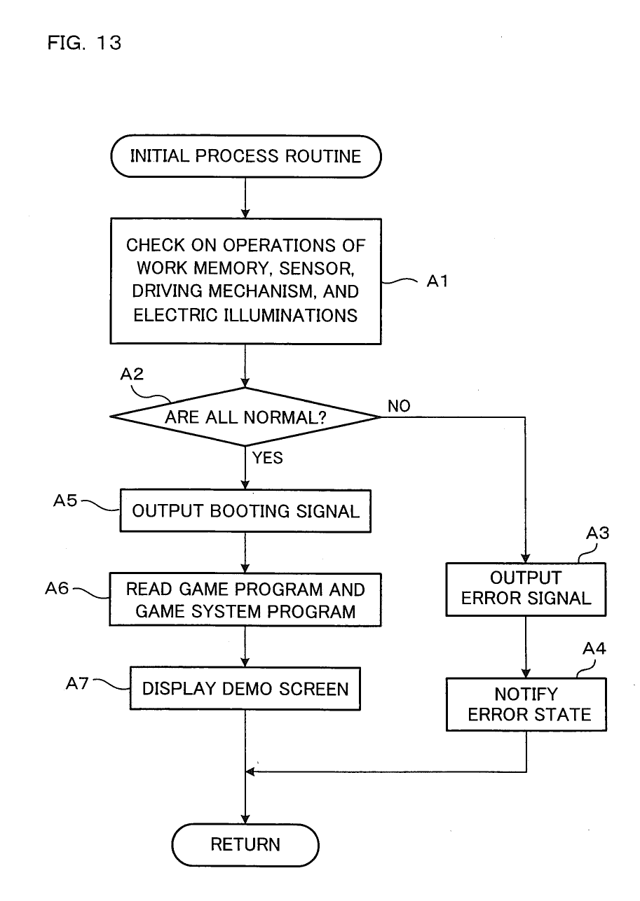

After executing the above processes, the main CPU 41 sequentially reads out and executes the game program and the game system program, thereby performing an initial process shown in FIG. 13.

(Processing Operation of the Gaming Machine 1: Initial Process)

In the followings, an initial process that is executed in the gaming machine 1 will be described. When the starting process shown in FIG. 12 is ended, the main CPU 41 reads out and executes an initial process routine shown in FIG. 13 from the RAM 43.

First, an operation check of each work memory of the RAM 43 and the like, an operation check of various sensors and an operation check of various electric spectaculars are performed (A1). Then, it is determined whether all check results are normal or not (A2). When it is determined that all check results are not normal (A2, NO), an abnormal signal is outputted (A3) and the top lamps 49 and the like are turned on, so that an abnormal state is notified (A4) and this routine is ended.

In the meantime, when it is determined that all check results are normal (A2, YES), a starting signal is outputted (A5). Then, the game program and the game system program are read out from the RAM 43 (A6). After that, based on the programs read, a demo screen is displayed on the central liquid crystal panel 5B and the like (A7), and this routine is ended.

(Processing Operation of the Gaming Machine 1: Game Executing Process)

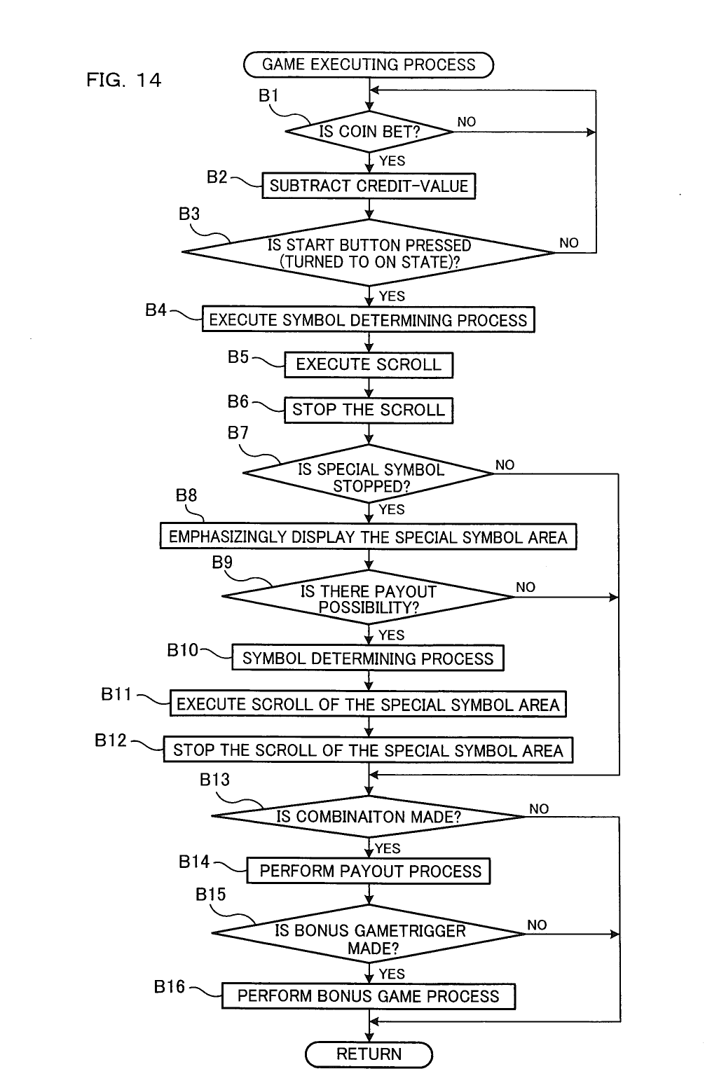

In the followings, a game executing process will be described with reference to FIG. 14. When the game executing process routine is carried out, the main CPU 41 determines whether a coin is bet or not (B1). In this process, it is determined whether an input signal due to a push of the 1-BET button 26 or MAX-BET button 27 is received or not. When it is determined that a coin is not bet (B1, N0), the step of B1 is re-executed, so that the CPU waits until a coin is bet.

In the meantime, when it is determined that a coin is bet (B1, YES), the credit-number stored in the RAM 43 is subtracted in accordance with the coin-number (B2). Meanwhile, when the number of coins bet is greater than the credit-number stored in the RAM 43, the step of B2 is re-executed without subtracting the credit-number. In addition, when the number of coins bet exceeds the upper limit (in this embodiment, 50 pieces) allowing a player to bet a coin in a one game, a step of B3 is executed without subtracting the credit-number.

Next, it is determined whether the start button is ON or not (B3). When it is determined that the start button is not ON (B3, NO), the process is returned to the step of B1. Meanwhile, when it is determined that the start button is not ON (for example, the start button is not ON and an instruction to end the game is inputted), it is canceled the subtraction result in the step of B2.

In the meantime, when it is determined that the start button is ON (B3, YES), a symbol determining process is executed (B4). In other words, nine symbols 190 are stopped which are stopped on the display windows 151 to 153. Meantime, the information of the symbols determined is temporarily stored in the RAM 43.

Then, the symbols 180 of the display windows 151 to 153 are scrolled (B5). After the scroll of the symbols 180 is started and then a predetermined time (base time) has elapsed, the symbol matrix determined in the step of B4 is stopped (first rearrangement) in the display windows 151 to 153 (B6).

Then, it is determined whether a special symbol 190 is rearranged in the first rearrangement (B7). In other words, based on the information of the symbols determined in the symbol determining process (B4), which is stored in the RAM 43, it is determined whether a special symbol 190 is rearranged. Meantime, the invention is not limited thereto. For example, the determination may be carried out, based on the symbols that are actually stopped on the display windows 151 to 153. When a special symbol 190 is rearranged (B7, YES), an area in which the special symbol 190 is arranged is emphasizingly displayed (B8). In other words, as shown in the top of FIG. 4, the contour line of the grid of the area in which the special symbol 190 is arranged is emphasizingly displayed in a thicker line than those of the other grids.

Like this, the area in which the special symbol 190 is rearranged is emphasizingly displayed, so that a player can easily fix the eyes on the grids in which the second rearrangement is executed.

Then, it is determined, in the area in which the special symbol 190 is rearranged, whether there is a possibility that a payout is awarded to a player, as a result of the second rearrangement (B9). In other words, it is determined whether there is a payout possibility by verifying all the combinations in which any one of the symbol “7” 188 or symbol “WILD” 189 is applied to the area in which the special symbol 190 is rearranged.

When there is a payout possibility, a symbol is determined which will be rearranged in the area in which the special symbol 190 is rearranged (B10). Meantime, the information of the symbol determined is temporarily stored in the RAM 43.

Then, a scroll display is started in the area in which the special symbol 190 is rearranged (B11). After a predetermined time (base time) has elapsed since the scroll display, the symbol determined in the process of B10 is stopped (secondly rearranged) in the area in which the special symbol 190 is rearranged (B12).

When a special symbol 190 is not stopped in the process of B7 (B7, NO), when there is no possibility of a payout by the second rearrangement (B9, NO) and after the process of B12, it is determined whether a combination is made or not, i.e., whether a combination of the symbols 180 stopped on the display windows 151 to 153 is a winning combination or not (B13).

Like this, when there is no possibility of a payout by the second rearrangement in the process of B9, the processes of B11 and B12 are skipped, so that a second variable display is prohibited. Since it is not necessary for a player to see a variable display that is not related to a payout, a player's stress can be relieved.

In the process of B13, when it is determined that the combination is not a winning combination (B1, NO), this routine is ended. In the mean time, when it is determined that the combination is a winning combination (B13, YES), a payout process is executed (B14). In other words, a payout-number of coins based on the winning combination made is calculated. When the coins to be paid out are stored, a predetermined number of credits are added to the credit-number stored in the RAM 43. In the mean time, when the coins are paid out, a control signal is transmitted to the hopper 64, so that a predetermined number of coins are paid out through the coin receiving portion 19.

Then, it is determined whether a bonus trigger is made as a winning combination (B15). In other words, it is determined whether a combination of the symbol “SUN” 181 is arranged on the payline L in the display windows 151 to 153. When it is determined that a bonus trigger is not made (B15, NO), this routine is ended. In the mean time, when it is determined that a bonus trigger is made (B15, YES), a bonus game process is executed (B11).

During the bonus game process, a gaming state is shifted to a bonus game from a base game (basic game). To be more specific, a free game is awarded which allows a player to play a game for a predetermined number of times (10 times in this embodiment), without betting a coin.

Like this, a player who plays a game with the slot machine 1 can expect a payout by a result of the second rearrangement in the same display windows 151 to 153 as well as a payout by a result of the first rearrangement. Thus, an easy and new entertainment characteristic can be provided.

### Second Embodiment

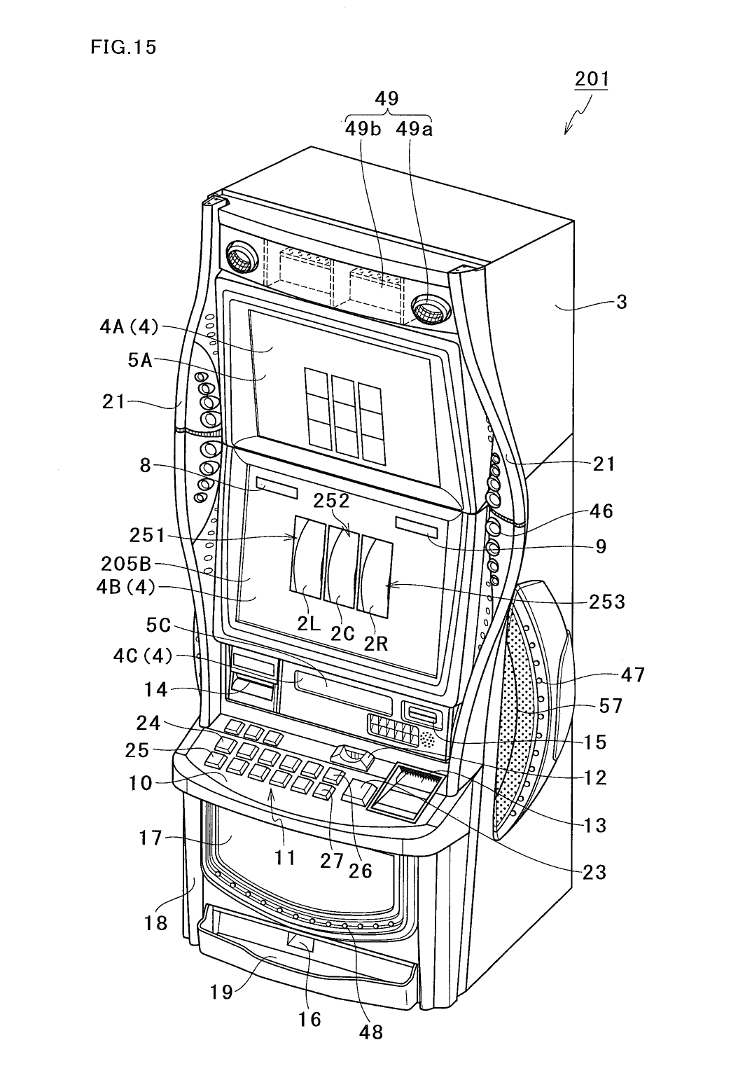

A second embodiment of the invention will be described with reference to FIG. 15. Meantime, the same members as in the first embodiment are indicated by the same reference numerals and the description thereof will be omitted.

(Display State)

An example in which the gaming machine 101 is applied to a slot machine 201 will be described. FIG. 14 is an external perspective view showing an outlined structure of the slot machine 2 01. The slot machine 201 of this embodiment is such structured that a central liquid crystal panel 205B arranges the symbols 180 by a mechanical reel manner. Meantime, since the display state is same as that of the first embodiment, the description thereof is omitted.

(Mechanical Structure: Schematic Structure)

Like the first embodiment, the central variable display unit 4B is a rotating symbol display panel on which a player always fixes the eyes. The variable display unit 4B has a transparent central liquid crystal panel 5B that is fixed to the front door of the cabinet 3. The central liquid crystal panel 205B is provided with three display windows 151 to 153 to be transmissive, as a display area on which the symbols 180 are rearranged. In addition, reels 2L, 2C, 2R are disposed at a backside of the central liquid crystal panel 205B.

Each of the reels 2L, 2C, 2R has an external shape of a cylinder provided to a same axis and includes the symbol columns depicted on an outer circumference surface thereon. The respective reels 2L, 2C, 2R are adapted to rotate in a constant rotation (for example, 80 revolutions per minute). The respective reels 2L, 2C, 2R are such structured that at least three symbols can be seen through the display windows 151, 152, 153. In addition, an image can be displayed on the central liquid crystal panel 5B corresponding to the display windows 151, 152, 153 and an image effect can be made by the reels 2L, 2C, 2R.

(Electrical Structure)

The slot machine 201 has a reel driving circuit (not show) connected to the main body PCB 60. The main body PCB controls the reel driving circuit in accordance with a control signal from the main CPU 41. The reel driving circuit drives step motors connected to the reels 2L,2C, 2R, thereby executing a rotation control of the reels 2L, 2C, 2R.

To be more specific, the reel driving circuit includes a FPGA (Field Programmable Gate Array) and a driver. The FPGA is a programmable electronic circuit such as LSI and serves as a control circuit of the step motor 152. The driver serves as an amplifying circuit of a pulse to be inputted into the step motor 152. The motor driving circuit is connected with the step motors to rotate the respective reels 2L, 2C, 2R. The step motors are step motors of a 1-2 phase exciting type.

In the invention, the exciting type of the step motor is not particularly limited. For example, a 2-phases exciting type, a 1-phase exciting type may be adopted. In addition, a DC motor may be adopted instead of the step motor. When a DC motor is adopted, the sub CPU 155 is connected with a D/A converter and a servo amplifier, sequentially. The servo amplifier is connected with the DC motor. In addition, a rotating position of the DC motor is detected by a rotary encoder and a current rotating position of the DC motor is supplied, as data, to a deviation counter from the rotary encoder.

In addition, the main body PCB 60 is associated with an index detection circuit and a position change detection circuit. The index detection circuit is to detect positions of the reels 2L, 2C, 2R and can detect loss of synchronism of the reels 2L, 2C, 2R.

The position change detection circuit detects a change in stop positions of the reels 2L, 2C, 2R after the rotations of the reels 2L, 2C, 2R are stopped. For example, the position change detection circuit detects a change in the stop positions of the reels 2L, 2C, 2R, which is related to a case where the stop positions are changed to make a combination of the symbols which will forcibly be a winning combination by a player even though the combination of the symbols is actually not a winning combination. The position change detection circuit detects, for example pins (not shown) attached at a predetermined distance in the reels 2L, 2C, 2R, thereby detecting a change in the stop positions of the reels 2L, 2C, 2R.

In the slot machine 201 as described above, the respective reels 2L, 2C, 2R are rotated and three symbols 180 of the respective display windows 151 to 153 are stopped, respectively, so that the first rearrangement is executed. Further, in the first rearrangement, when a special symbol 190 is rearranged, an area in which the special symbol 190 is displayed is emphasizingly displayed and an image of the variable display of the second rearrangement is displayed on the central liquid crystal panel 205B. Like this, also in this second embodiment, the same effects as those of the first embodiment are achieved.

In the meantime, the slot machine 1 and the slot machine 201 of this embodiment are structured in such a manner that when a special symbol 190 is rearranged in the first rearrangement, an area in which the special symbol 190 is rearranged is emphasizingly displayed. However, the invention is not limited thereto.

In addition, the slot machine 1 and the slot machine 201 of this embodiment prohibit an execution of the variable display when there is no payout possibility in the second rearrangement. However, the invention is not limited thereto.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a display area in which a plurality of symbols are arranged;
a game that awards a payout in accordance with a relation among the symbols arranged; and
a controller that operates:
(a1) to execute a first rearrangement of rearranging the symbols on the display area, based on a predetermined timing;
(a2) to determine whether the symbols rearranged on the display area include a special symbol;
(a3) when it is determined that the symbols include a special symbol, to start a variable display in the area in which the special symbol is rearranged;
(a4) to execute a second rearrangement of rearranging any one of the symbols except the special symbol, as a stop mode of the variable display in the area; and
(a5) to award a payout in accordance with a relation among the symbols rearranged, as a result of the first rearrangement and/or the second rearrangement.

2. A gaming machine comprising:
a display area of a matrix type having a plurality of grids in which a plurality of symbols are respectively arranged;
a game that awards a payout in accordance with a relation among the symbols arranged; and
a controller that operates:
(b1) to execute a first rearrangement of rearranging the symbols on the display area, based on a predetermined timing;
(b2) to determine whether the symbols rearranged on the display area include a special symbol;
(b3) when it is determined that the symbols include a special symbol, to emphasizingly display an area of the grid in which the special symbol is rearranged and to start a variable display in the area of the grid;
(b4) to execute a second rearrangement of rearranging any one of the symbols except the special symbol, as a stop mode of the variable display in the area; and
(b5) to award a payout in accordance with a relation among the symbols rearranged, as a result of the first rearrangement and/or the second rearrangement.

3. A gaming machine comprising:
a display area in which a plurality of symbols are arranged;
a game that awards a payout in accordance with a relation among the symbols arranged; and
a controller that operates:
(c1) to execute a first rearrangement of rearranging the symbols on the display area, based on a predetermined timing;
(c2) to determine whether the symbols rearranged on the display area include a special symbol;
(c3) when it is determined that the symbols include a special symbol, to determine whether there is a possibility that the payout is awarded;
(c4) when there is a possibility that the payout is awarded, to start a variable display in the area in which the special symbol is rearranged;
(c5) to execute a second rearrangement of rearranging any one of the symbols except the special symbol, as a stop mode of the variable display in the area;
(c6) when there is no possibility that the payout is awarded, to prohibit the variable display in the area in which the special symbol is rearranged; and
(c7) to award a payout in accordance with a relation among the symbols rearranged, as a result of the first rearrangement and/or the second rearrangement.

4. A gaming machine comprising:
a display area of a matrix type having a plurality of grids in which a plurality of symbols are respectively arranged;
a game that awards a payout in accordance with a relation among the symbols arranged; and
a controller that operates:
(d1) to execute a first rearrangement of rearranging the symbols on the display area, based on a predetermined timing;
(d2) to determine whether the symbols rearranged on the display area include a special symbol;
(d3) when it is determined that the symbols include a special symbol, to determine whether there is a possibility that the payout is awarded;
(d4) when there is a possibility that the payout is awarded, to emphasizingly display an area of the grid in which the special symbol is rearranged and to start a variable display in the area of the grid;
(d5) to execute a second rearrangement of rearranging any one of the symbols except the special symbol, as a stop mode of the variable display in the area;
(d6) when there is no possibility that the payout is awarded, to prohibit the variable display in the area in which the special symbol is rearranged; and
(d7) to award a payout in accordance with a relation among the symbols rearranged, as a result of the first rearrangement and/or the second rearrangement.

5. A playing method of a gaming machine using a display area in which a plurality of symbols are arranged, a game that awards a payout in accordance with a relation among the symbols arranged and a controller that operates as described in the steps of (e1) to (e5), the method comprising the steps of:
(e1) executing a first rearrangement of rearranging the symbols on the display area, based on a predetermined timing;
(e2) determining whether the symbols rearranged on the display area include a special symbol;
(e3) when it is determined that the symbols include a special symbol, starting a variable display in the area in which the special symbol is rearranged;
(e4) executing a second rearrangement of rearranging any one of the symbols except the special symbol, as a stop mode of the variable display in the area; and
(e5) awarding a payout in accordance with a relation among the symbols rearranged, as a result of the first rearrangement and/or the second rearrangement.
